(19) United States
(12) Patent Application Publication
(10) Pub. No.: US 2014/0041635 A1
(43) Pub. Date: Feb. 13, 2014

(54) FUEL RAIL CONNECTOR

(71) Applicants: John Edward Keller, Royal Oak, MI (US); James F. Reichenbach, Shelby Township, MI (US)

(72) Inventors: John Edward Keller, Royal Oak, MI (US); James F. Reichenbach, Shelby Township, MI (US)

(73) Assignee: GM GLOBAL TECHNOLOGY OPERATIONS LLC, Detroit, MI (US)

(21) Appl. No.: 13/570,693

(22) Filed: Aug. 9, 2012

(51) Int. Cl. F02M 55/02

(52) U.S. Cl. 123/469

(57) ABSTRACT

A connector for coupling a high pressure fuel line with a fuel rail, the connector including a connector body disposed along a longitudinal axis, and having a first end portion, and a second end portion opposite the first end portion. The connector body is configured to couple with a high pressure fuel line at the first end portion, and is configured to couple with a fuel rail at the second end portion. The connector body defines a fluid passage along the longitudinal axis between the first end portion and the second end portion. The fluid passage includes an orifice portion having a length along the longitudinal axis and a diameter, and the length of the orifice portion is more than 3 times greater than the diameter of the orifice portion.

### TECHNICAL FIELD

The present invention relates generally to a connector for coupling a high pressure fuel line with a fuel rail.

### BACKGROUND

A fuel rail is a pipe that is configured to deliver liquid fuel to individual fuel injectors within an internal combustion engine. Fuel may be supplied to the fuel rail from a fuel pump that may draw the liquid fuel out of a reserve tank, pressurize it, and convey it to the fuel rail using one or more high pressure fuel lines. Each fuel injector may selectively inject/meter an appropriate amount of fuel into the cylinder at a predetermined time in the compression stroke, where it may be subsequently combusted to extract mechanical energy.

### SUMMARY

A connector for coupling a high pressure fuel line with a fuel rail includes a connector body disposed along a longitudinal axis, and having a first end portion, and a second end portion opposite the first end portion. The connector body may be configured to couple with a high pressure fuel line at the first end portion, and may be configured to couple with a fuel rail at the second end portion.

The connector body defines a fluid passage along the longitudinal axis between the first end portion and the second end portion that includes an orifice portion having a length along the longitudinal axis and a diameter. To appropriately isolate any harmonics of the high pressure fuel line from any harmonics of the fuel rail, the length of the orifice portion may be more than 3 times greater than the diameter of the orifice portion.

The fluid passage may further include a high pressure fuel inlet chamber disposed at the first end portion, and a flow expanding chamber disposed at the second end portion. The orifice portion may be disposed between the high pressure fuel inlet chamber and flow expanding chamber along the longitudinal axis. In one configuration, the average diameter of the high pressure fuel inlet chamber may be more than three times greater than the diameter of the orifice portion. Likewise, the average diameter of the flow expanding chamber may also be more than three times greater than the diameter of the orifice portion.

The fluid passage may further include a fluid converging portion disposed between the high pressure fuel inlet chamber and the orifice portion, and a fluid diverging portion disposed between the flow expanding chamber and the orifice portion. The fluid converging portion may have a decreasing diameter from a diameter of the high pressure fuel inlet chamber to a diameter of the orifice portion, and the fluid diverging portion may have an increasing diameter from a diameter of the orifice portion to a diameter of the flow expanding chamber. As such, the diameter of the orifice portion may then be less than each of the diameter of the fuel inlet chamber and the diameter of the flow expanding chamber.

In one configuration, the fuel inlet chamber may have a diameter of between 4.0 mm and 7.0 mm; the flow expanding chamber may have a diameter of between 10.0 mm and 14.0 mm; the orifice portion may have a diameter of between 1.0 mm and 1.5 mm; and the orifice portion may have a length of between 6.0 mm and 15.0 mm. In another configuration, the diameter of the orifice portion may be less than 2.0 mm, and the length of the orifice portion is greater than 6.0 mm. In still another configuration, the diameter of the orifice portion may be between 1.0 mm and 1.5 mm, and the length of the orifice portion may be between 10.0 mm and 15.0 mm.

In general, the orifice portion may inhibit the transmission of high frequency fluid pressure oscillations through the fluid passage. Such high frequency fluid pressure oscillations may include pressure oscillations at a frequency greater than 700 Hz.

The connector body may be configured to couple with the high pressure fuel line using a ball connector, and the connector body is configured to couple with the fuel rail using a brazed connector.

Likewise, a fuel delivery system may include a high pressure fuel line; a high pressure fuel pump configured to provide a pressurized liquid fuel to the high pressure fuel line at a first pumping frequency; an internal combustion engine having a combustion chamber; a fuel rail; a fuel injector configured to selectively deliver a liquid fuel from the fuel rail to the combustion chamber at a second injection frequency; and a connector of the kind described above, for coupling the high pressure fuel line with the fuel rail.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic partial cross-sectional view of a fuel delivery system including a connector for coupling a high pressure fuel line with a fuel rail.

FIG. 2 is a dimensioned schematic cross-sectional view of a connector for coupling a high pressure fuel line with a fuel rail.

### DETAILED DESCRIPTION

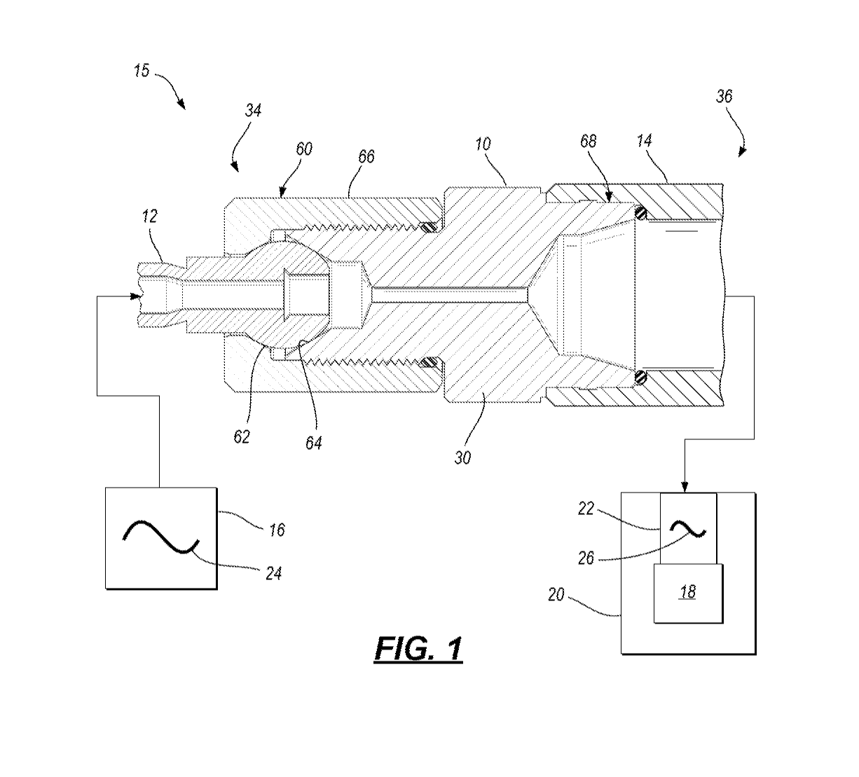

Referring to the drawings, wherein like reference numerals are used to identify like or identical components in the various views, FIG. 1 schematically illustrates a connector 10 for coupling a high pressure fuel line 12 with a fuel rail 14 within a fuel delivery system 15. The high pressure fuel line 12 may direct liquid fuel, such as, for example, gasoline fuel, diesel fuel, and/or ethanol or methanol blended fuels from a high pressure fuel pump 16 to the fuel rail 14, where it may be selectively provided into one or more combustion chambers 18 of an internal combustion engine 20 via one or more selectively actuatable fuel injector valves 22.

As may be appreciated, the high pressure fuel pump 16 may operate at a first, pumping frequency 24, and the one or more fuel injector valves 22 may operate at a second, injection frequency 26. The pumping frequency 24 may be dictated by the physical dimensions of the pump 16, together with the desired fuel pressure/flow rates. The injection frequency 26 may largely depend on the speed and power demands of the engine 20. During certain operating conditions, the pumping frequency 24 and injection frequency 26 may resonate along the high pressure fuel line 12 and fuel rail 14, if not properly isolated.

Therefore, the connector 10 may be particularly configured to inhibit the transmission of high frequency fluid pressure oscillations between the high pressure fuel line 12 and fuel rail 14. As such, any acoustic resonance of the fuel line 12/connector 10/fuel rail 14 above, for example, 700 Hz may be attenuated by isolating the fuel line 12 from the fuel rail 14, and thus altering the structural modes of the assembly.

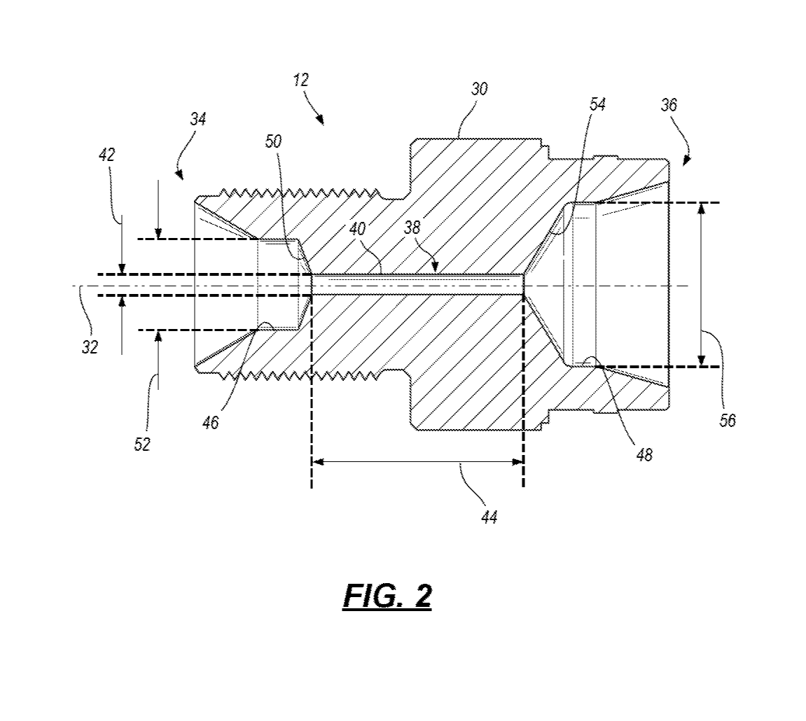

To accomplish the fluid pressure isolation, the connector 10 may include a a connector body 30 disposed along a longitudinal axis 32, as more clearly illustrated in FIG. 2. The connector body 30 may include a first end portion 34 configured to couple with the high pressure fuel line 12, and may include a second end portion 36 that is opposite the first end portion 34, and is configured to couple with the fuel rail 14.

The connector body 30 may define a fluid passage 38 between the first end portion 34 and the second end portion 36, which may generally be aligned along the longitudinal axis 32. The fluid passage may include an orifice portion 40 that may be operative to reduce the pressure of the fuel between the high pressure fuel line 12 and the fuel rail 14. As typical with pressure-reducing orifices, the orifice portion 40 of the connector body 30 may have a diameter 42 (i.e., cross-sectional area) that is sufficient to accomplish a desired pressure reduction between the high pressure fuel line 12 and the fuel rail 14. In one configuration, the diameter 42 may be less than 2.0 mm. For example, in one configuration, the diameter 42 may be between 1.0 mm and 1.5 mm.

Unlike typical pressure-reducing orifices that have a small/negligible length, however, the length 44 of the current orifice portion 40 may be elongated to isolate high frequency pressure oscillations of the high pressure fuel line 12 from high frequency pressure oscillations of the fuel rail 14. For example, in one configuration, the length 44 of the orifice portion 40 may be more than 3 times greater than the diameter 42 of the orifice portion 40. As such, in one configuration, the length 44 of the orifice portion 40 may be between 6.0 mm and 15.0 mm. In another configuration, the length 44 of the orifice portion 40 may be between 10.0 mm and 15.0 mm.

The connector body 30 may further define a fluid chamber on either side of the orifice portion 40. At the first end portion 34, the fluid passage 38 may include a high pressure fuel inlet chamber 46 that may be in direct fluid communication with the high pressure fuel line 12, between the fuel line 12 and the orifice portion 40. At the second end portion 36, the fluid passage 38 may include a flow expanding chamber 48 that may be in direct fluid communication with the fuel rail 14, between the fuel rail 14 and the orifice portion 40. As such, the orifice portion 40 may be disposed between the high pressure fuel inlet chamber 46 and flow expanding chamber 48 along the longitudinal axis 32.

In one configuration, the fluid passage 38 may further include a fluid converging portion 50 disposed between the high pressure fuel inlet chamber 46 and the orifice portion 40. The fluid converging portion 50 may aid in providing a convergent fuel flow from the high pressure fuel line 12 to the orifice portion 40. As such, the fluid converging portion 50 may have a decreasing diameter from a diameter 52 of the high pressure fuel inlet chamber 46 to the diameter 42 of the orifice portion 40. The average diameter 52 of the high pressure fuel inlet chamber 46 may be, for example, greater than three times the diameter 42 of the orifice portion 40. In one configuration, the diameter 52 of the high pressure fuel inlet chamber 46 may be between 4.0 mm and 7.0 mm.

The fluid passage 38 may further include a fluid diverging portion 54 disposed between the flow expanding chamber 48 and the orifice portion 40. The fluid diverging portion 54 may aid in providing a divergent fuel flow from the orifice portion 40 to the flow expanding chamber 48. As such, the fluid diverging portion 54 may have an increasing diameter from the diameter 42 of the orifice portion 40 to a diameter 56 of the flow expanding chamber 48. The average diameter 56 of the flow expanding chamber 48 may be, for example, greater than three times the diameter 42 of the orifice portion 40. In one configuration, the average diameter 56 of the flow expanding chamber 48 may be between 10.0 mm and 14.0 mm. Therefore, as may be appreciated, the diameter 42 of the orifice portion 40 may be less than each of the diameter 52 of the fuel inlet chamber 46 and the diameter 56 of the flow expanding chamber 48.

Referring again to FIG. 1, the high pressure fuel line 12 may be coupled with the connector 10 using a ball-type union 60. In this manner of coupling, the high pressure fuel line 12 may include a ball-shaped fitting 62 on the end of the fuel line 12 that is configured to nest within a flanged portion 64 of the connector 10. An attachment nut 66 may be threaded onto the connector 10 in a manner that forces the ball-shaped fitting 62 into the flanged portion 64. During operation/use within a vehicle, such a fitting 60 may permit slight movement/articulation between the high pressure fuel line 12 and the connector 10, while maintaining a fluid-tight seal between the fuel line 12 and the passageway 38 of the connector 10. This may be beneficial in a dynamic environment where there is a likelihood that components may move relative to each other.

At the second end portion 36, the connector 10 may be configured to mate with the fuel rail 14 such as through a brazed coupling. For example, as shown, the connector 10 may include a narrowed portion 68 that may be substantially inserted within the fuel rail 14. Following insertion, a brazing material (not shown) may be wicked between the connector 10 and the fuel rail 14 at the interface.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A connector for coupling a high pressure fuel line with a fuel rail, the connector comprising:
a connector body having a first end portion, and a second end portion opposite the first end portion,
the connector body being configured to couple with a high pressure fuel line at the first end portion, and being configured to couple with a fuel rail at the second end portion;
the connector body defining a fluid passage between the first end portion and the second end portion;
wherein the fluid passage includes an orifice portion having a length and a diameter; and
wherein the length of the orifice portion is more than 3 times greater than the diameter of the orifice portion.

2. The connector of claim 1, wherein the fluid passage further includes:
a high pressure fuel inlet chamber disposed at the first end portion;
a flow expanding chamber disposed at the second end portion; and
wherein the orifice portion is disposed between the high pressure fuel inlet chamber and flow expanding chamber.

3. The connector of claim 2, wherein the average diameter of the high pressure fuel inlet chamber is more than three times greater than the diameter of the orifice portion.

4. The connector of claim 2, wherein the average diameter of the flow expanding chamber is more than three times greater than the diameter of the orifice portion.

5. The connector of claim 2, wherein the fluid passage further includes:
a fluid converging portion disposed between the high pressure fuel inlet chamber and the orifice portion, the fluid converging portion having a decreasing diameter from a diameter of the high pressure fuel inlet chamber to a diameter of the orifice portion;
a fluid diverging portion disposed between the flow expanding chamber and the orifice portion, the fluid diverging portion having an increasing diameter from a diameter of the orifice portion to a diameter of the flow expanding chamber; and
wherein the diameter of the orifice portion is less than each of the diameter of the fuel inlet chamber and the diameter of the flow expanding chamber.

6. The connector of claim 2, wherein the fuel inlet chamber has a diameter of between 4.0 mm and 7.0 mm;
wherein the flow expanding chamber has a diameter of between 10.0 mm and 14.0 mm;
wherein the orifice portion has a diameter of between 1.0 mm and 1.5 mm; and
wherein the orifice portion has a length of between 6.0 mm and 15.0 mm.

7. The connector of claim 1, wherein the diameter of the orifice portion is less than 2.0 mm; and
wherein the length of the orifice portion is greater than 6.0 mm.

8. The connector of claim 7, wherein the orifice portion inhibits the transmission of high frequency fluid pressure oscillations through the fluid passage; and
wherein high frequency fluid pressure oscillations include pressure oscillations at a frequency greater than 700 Hz.

9. The connector of claim 7, wherein the diameter of the orifice portion is between 1.0 mm and 1.5 mm; and
wherein the length of the orifice portion is between 10.0 mm and 15.0 mm.

10. The connector of claim 1, wherein the connector body is configured to couple with the high pressure fuel line using a ball connector.

11. The connector of claim 1, wherein the connector body is configured to couple with the fuel rail using a brazed connector.

12. A fuel delivery system comprising:
a high pressure fuel line;
a high pressure fuel pump configured to provide a pressurized liquid fuel to the high pressure fuel line at a first pumping frequency;
an internal combustion engine having a combustion chamber;
a fuel rail;
a fuel injector configured to selectively deliver a liquid fuel from the fuel rail to the combustion chamber at a second injection frequency; and
a connector configured to fluidly couple the high pressure fuel line with the fuel rail, the connector including:
a connector body disposed along a longitudinal axis;
the connector body having a first end portion, and a second end portion opposite the first end portion,
the connector body being configured to couple with the high pressure fuel line at the first end portion, and being configured to couple with the fuel rail at the second end portion;
the connector body defining a fluid passage along the longitudinal axis between the first end portion and the second end portion;
wherein the fluid passage includes an orifice portion having a length along the longitudinal axis and a diameter; and
wherein the length of the orifice portion is more than 3 times greater than the diameter of the orifice portion.

13. The system of claim 12, wherein the fluid passage defined by the connector body further includes:
a high pressure fuel inlet chamber disposed at the first end portion;
a flow expanding chamber disposed at the second end portion; and
wherein the orifice portion is disposed between the high pressure fuel inlet chamber and flow expanding chamber along the longitudinal axis.

14. The system of claim 13, wherein the average diameter of the high pressure fuel inlet chamber is more than three times greater than the diameter of the orifice portion; and wherein the average diameter of the flow expanding chamber is more than three times greater than the diameter of the orifice portion.

15. The system of claim 13, wherein the fluid passage defined by the connector body further includes:
a fluid converging portion disposed between the high pressure fuel inlet chamber and the orifice portion, the fluid converging portion having a decreasing diameter from a diameter of the high pressure fuel inlet chamber to a diameter of the orifice portion;
a fluid diverging portion disposed between the flow expanding chamber and the orifice portion, the fluid diverging portion having an increasing diameter from a diameter of the orifice portion to a diameter of the flow expanding chamber; and
wherein the diameter of the orifice portion is less than each of the diameter of the fuel inlet chamber and the diameter of the flow expanding chamber.

16. The system of claim 13, wherein the fuel inlet chamber has a diameter of between 4.0 mm and 7.0 mm;
wherein the flow expanding chamber has a diameter of between 10.0 mm and 14.0 mm;
wherein the orifice portion has a diameter of between 1.0 mm and 1.5 mm; and
wherein the orifice portion has a length of between 6.0 mm and 15.0 mm.

17. The system of claim 12, wherein the diameter of the orifice portion is less than 2.0 mm; and
wherein the length of the orifice portion is greater than 6.0 mm.

18. The system of claim 17, wherein the orifice portion inhibits the transmission of high frequency fluid pressure oscillations through the fluid passage; and
wherein high frequency fluid pressure oscillations include pressure oscillations at a frequency greater than 700 Hz.

19. The system of claim 17, wherein the diameter of the orifice portion is between 1.0 mm and 1.5 mm; and
wherein the length of the orifice portion is between 10.0 mm and 15.0 mm.

20. The system of claim 12, wherein the connector body is configured to couple with the high pressure fuel line using a ball connector; and
wherein the connector body is configured to couple with the fuel rail using a brazed connector.
